(19) United States
(12) Patent Application Publication
(10) Pub. No.: US 2005/0158521 A1
(43) Pub. Date: Jul. 21, 2005

(54) Insulation and methods for making and securing insulation

(75) Inventor: Debasis Sanyal, Houston, TX (US)

Correspondence Address: BRACEWELL & PATTERSON, LLP;IP DOCKETING, P.O. BOX 61389, HOUSTON, TX, 77208-1389, US

(73) Assignee: Quietflex Manufacturing Company, L.P.

(21) Appl. No.: 11/039,120

(22) Filed: Jan. 19, 2005

Related U.S. Application Data
(60) Provisional application No. 60/537,771, filed on Jan. 20, 2004.

(51) Int. Cl. B32B 23/02

(52) U.S. Cl. 428/192

(57) ABSTRACT

Insulation for use with air conditioning equipment, methods for making insulation for use with air conditioning equipment, and methods for securing insulation to air conditioning equipment, include a fiberglass mat having a layer of adhesive disposed thereon, the layer of adhesive not being tacky.

### RELATED APPLICATION

The invention claims the benefit and priority of U.S. Provisional Patent Application No. 60/537,771 filed Jan. 20, 2004, entitled “Insulation and Methods for Making and Securing Insulation.”

### BACKGROUND OF THE INVENTION

1. Field of the Invention

The invention relates to insulation for use with air conditioning equipment, methods for making insulation for use with air conditioning equipment, and methods for securing insulation to air conditioning equipment.

2. Description of the Related Art

Many types of air conditioning equipment, such as coil housings, condenser housing, and some types of ductwork are provided with a layer of insulation, or insulation material, to insulate the air conditioning equipment in order to maintain the desired cool temperature of the air passing through such equipment. The use of the term “air conditioning equipment” also includes heating equipment, such as conventional furnaces, ductwork for heated air, and other types of heating equipment, as is known in the air conditioning industry. Typically, the insulation includes a mat, or panel, formed of conventional fiberglass material which has the desired insulation characteristics. Generally, the thickness of the fiberglass mat, or panel, would determine the insulation properties of the fiberglass mat or panel, as is known in the air conditioning industry. Many of these conventional fiberglass mats or panels will have a layer of various types of material applied to one of the outer surfaces of the fiberglass mat, as is known in the air conditioning industry. Examples of such materials include: a metallic foil, such as an aluminum foil layer; a thin glass mat layer, which is typically a black thin, glass, or fiberglass, sheet of material; or a thin layer of a heat resistant plastic film material.

All the foregoing known materials are secured to one of the outer surfaces, such as the top or bottom surface of a fiberglass mat, or pad, in a conventional manner as by gluing the layer of material to the fiberglass mat. In general, the surface, or outer surface, of the fiberglass mat, which has the layer of foil, plastic, or glass mat secured thereon, faces outwardly and is exposed to the ambient temperature outside the air conditioning equipment which is being insulated, as is known in the air conditioning industry. The other, or inner, surface of the fiberglass mat is typically secured to the desired surface upon the air conditioning equipment, as by gluing the fiberglass mat, or panel, to the desired surface of the air conditioning equipment. Typically, the insulation is glued on a metal surface of the air conditioning equipment, by spraying glue onto the metal surface of the air conditioning equipment or onto the inner surface of the fiberglass mat. Such insulation may be glued upon the metal surface of the air conditioning equipment in the factory in which the air conditioning equipment is manufactured, or perhaps the gluing step may be done at the job site where the air conditioning equipment is being installed in a building, or other structure.

It is common to use a water-based adhesive for the foregoing gluing step, and care must be taken so as to not move the fiberglass mat of the insulation, prior to the adhesive drying. Alternatively, hot melt adhesive has been used to bond fiberglass insulation to metal parts of air conditioning equipment, as by spraying or extruding the hot melt adhesive upon the metal surface or the inner surface of the fiberglass mat and bringing them into contact to bond them to each other while the hot melt adhesive is in a heated, tacky condition. The use of the term “tacky” is intended to mean that the adhesive is somewhat sticky to the touch and generally has an adhesive quality or condition.

Typically, the foregoing described insulation is made in the desired size and configuration desired by the manufacturer of the air conditioning equipment, and the insulation is typically shipped to the manufacturing plant of the air conditioning equipment manufacturer. In some instances, panels of insulation of a standard size may be manufactured and shipped to installers of air conditioning equipment, who may then cut the panels to the desired size at the job site where the air conditioning equipment is being installed.

There are some disadvantages associated with the foregoing described conventional insulation for use with air conditioning equipment. One of the disadvantages is that the spraying equipment, which may be used to spray the glue upon the insulation, or metal surface of the air conditioning equipment, can be messy during use of the spraying equipment, as well as require additional effort to keep the work space clean and safe after use of the spraying equipment. Additionally, such spraying equipment can be expensive to initially acquire.

Another disadvantage associated with the foregoing described conventional insulation is that dust, or fiberglass dust particles and/or fibers which may be disposed within the fiberglass mat can come out of the fiberglass mat through the lower, or inner surface, of the mat which has not had the foil, heat resistant plastic, or black glass mat secured thereto. To a lesser degree, fiberglass dust particles may pass through the side edges of the fiberglass mat insulation. Such fiberglass dust particles can be bothersome to individuals handling the insulation, in particular, individuals who are securing the insulation to the desired air conditioning equipment. The dust particles can cause a person's skin to itch, and such dust particles should, in general, not be inhaled by people handling the insulation. In this regard, the present invention is not intended to be a substitute for wearing proper protection against the inhaling of fiberglass dust particles, such as face masks, and other conventional protection to protect against undesired inhaling of fiberglass dust particles, as is known by those working with fiberglass.

Accordingly, prior to the development of the present invention, there has been no insulation for use with air conditioning equipment, methods for making insulation for use with air conditioning equipment, or methods of securing insulation to air conditioning equipment, which: does not require messy and expensive spraying equipment to secure the insulation to the air conditioning equipment; and reduces the amount of fiberglass dust particles and/or fibers which can escape from the insulation. Therefore, the air conditioning industry has sought insulation for use with air conditioning equipment, methods for making insulation for use with air conditioning equipment, and methods of securing insulation to air conditioning equipment which: are neat and do not require the use of expensive spraying equipment to secure the insulation to air conditioning equipment; and reduce the amount of fiberglass dust particles which can be released from the insulation.

### SUMMARY OF THE INVENTION

In accordance with the present invention, the foregoing advantages have been achieved through the present insulation for use with air conditioning equipment. The present invention may include a fiberglass mat having an outer surface, an inner surface, and a plurality of side edges; and a layer of adhesive disposed upon at least one of the surfaces, the layer of adhesive not being tacky, whereby the insulation may be readily handled and any fiberglass dust particles disposed within the fiberglass mat will be substantially prevented from passing through the layer of adhesive. A feature of this aspect of the present invention is that the layer of adhesive may be treated to become tacky, whereby the insulation may be secured to the air conditioning equipment, and the layer of adhesive may be treated by being heated to a temperature at which the layer of adhesive becomes tacky. The layer of adhesive may also be treated by water being applied to the layer of adhesive to make the layer of adhesive tacky. Another feature of the present invention is that a layer of adhesive may be disposed on at least some of the side edges of the fiberglass mat, and a layer of foil may be affixed to one of the surfaces of the fiberglass mat. An additional feature of the present invention is that the layer of adhesive may be a hot melt adhesive which is sprayed upon the fiberglass mat at a first temperature, and the adhesive may then be cooled to a second, lower temperature, whereby the layer of hot melt adhesive is not tacky. An additional feature of the present invention is that the hot melt adhesive, upon being reheated to a temperature greater than the second temperature, is tacky and may be secured to the air conditioning equipment.

In accordance with the invention the foregoing advantages have also been achieved through the present method for making insulation for use with air conditioning equipment. This method of the present invention may include the steps of: providing a fiberglass mat having an outer surface, an inner surface, and a plurality of side edges; and applying a layer of adhesive upon at least one of the surfaces, the layer of adhesive not being tacky, whereby the insulation may be readily handled and any fiberglass dust particles disposed within the fiberglass mat will be substantially prevented from passing through the layer of adhesive.

A feature of this aspect of the present invention may include the step of utilizing an adhesive which may be subsequently treated to become tacky, whereby the insulation may be secured to the air conditioning equipment. Another feature of this aspect of the present invention may include the steps of utilizing as the adhesive a hot melt adhesive, and the adhesive is applied by spraying the adhesive upon the fiberglass mat at the first temperature, and the adhesive is then cooled to a second temperature, which is lower than the first temperature, whereby the layer of hot melt adhesive is not tacky. An additional feature of this aspect of the present invention may include the step of utilizing a hot melt adhesive which may be subsequently reheated to a temperature greater than the second temperature, whereby the layer of the adhesive may become tacky and adhere to the air conditioning equipment.

In accordance with another aspect of the present invention, the foregoing advantages have also been achieved through the present method of securing insulation to air conditioning equipment. This method of the present invention may comprise the steps of: utilizing as the insulation a fiberglass mat having an outer surface, an inner surface, and a plurality of side edges, at least one of the surfaces having disposed thereon a layer of adhesive, the layer of adhesive not being tacky; heating the layer of adhesive to make the adhesive tacky; and placing the surface of the fiberglass mat with the tacky adhesive thereon, into contact with the air conditioning equipment to secure the insulation to the air conditioning equipment. An additional feature of this aspect of the present invention may include the step of using a heat lamp to heat the adhesive. A further feature of this aspect of the present invention may include the step of using a heating plate to heat the adhesive.

The insulation and methods of the present invention, when compared with previously proposed insulation and methods have the advantages of: being neat in their use; not requiring expensive spraying equipment to secure the insulation to the air conditioning equipment; and reducing the amount of fiberglass particles which may escape from the fiberglass mat.

### BRIEF DESCRIPTION OF THE DRAWING

In the drawing:

FIG. 1 is a perspective view of air conditioning equipment with insulation, in accordance with the present invention, secured thereto;

FIG. 2 is a perspective view of insulation in accordance with the present invention;

FIG. 3 is a partial cross-sectional view of the insulation of FIG. 2, taken along lines 3-3 of FIG. 2; and

FIG. 4 is a plan view of an assembly line that may be used for making the insulation of FIG. 2 of the present invention.

While the invention will be described in connection with the preferred embodiment, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF THE INVENTION AND SPECIFIC EMBODIMENTS

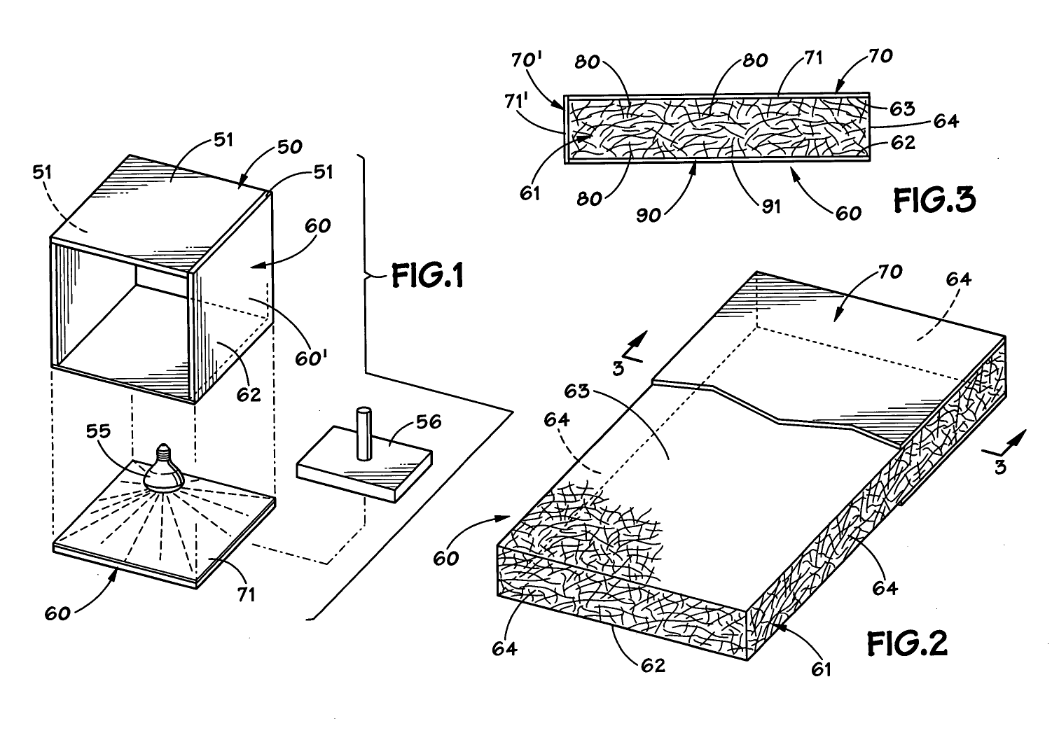

With reference to FIG. 1, air conditioning equipment 50 is shown with insulation 60 of the present invention applied to an outer wall surface 51 of air conditioning equipment 50. Air conditioning equipment 50 as shown may be considered representative of an air conditioning coil housing, an air conditioning condenser housing, or a section of rigid air conditioning ductwork. The air conditioning equipment 50 is conventionally formed of any suitable metallic material, such as conventional sheet metal, or any other material having the requisite strength and corrosion resistance characteristics to permit its use for air conditioning equipment 50. Typically, all of the outer surfaces 51 of air conditioning equipment 50 would have insulation 60 secured thereto; however, for ease of illustration, only one piece of insulation 60, or insulation panel 60′, is illustrated.

With reference to FIGS. 1-3, insulation 60 of the present invention for use with air conditioning equipment 50 generally includes a fiberglass mat 61 having an outer surface, an inner surface 63 and a plurality of side edges 64, four side edges 64, being illustrated in FIG. 2. It is of course understood that the number of side edges would be dependent upon the configuration of insulation 60, or fiberglass mat 61. Insulation 60 as shown in FIGS. 1 and 2 has a generally rectangular configuration, and the configuration of the insulation 60 is typically selected to conform the outer wall surface 51 of air conditioning equipment 50 to which insulation 60 is to be secured, such as a square, circular, or triangular configuration, etc. By use of the terms outer surface and inner surface 62, 63 for fiberglass mat 61 is meant that outer surface 62 of mat 61 faces outwardly from air conditioning equipment 50 and is disposed adjacent to the ambient air surrounding air conditioning equipment 50. If a layer of foil, or other material, is disposed upon outer surface 62 of mat 61, as will be hereinafter described, the layer of foil is applied to outer surface 62 of mat 61. The inner surface 62 is the surface of mat 61 which is secured, as will be hereinafter described in greater detail, to the outer wall surface 51 of air conditioning equipment 50.

With reference to FIGS. 2 and 3, insulation 60 also includes a layer 70 of adhesive 71 disposed upon at least one of the surfaces 62, 63 of the mat 61, and preferably upon the inner surface 62 of fiberglass mat 61. The layer 70 of adhesive 71 is not tacky, whereby insulation 60 may be readily handled by individuals handling insulation 60, such as the individuals who would be securing insulation 60 to air conditioning equipment 50, or the individuals who, after insulation 60 has been manufactured, would be handling insulation 60 for purposes of shipping and packaging insulation 60 for shipment to the individuals who would be securing insulation 60 to air conditioning equipment 50. The adhesive layer 70 generally functions to substantially prevent any fiberglass dust particles, and/or loose fiberglass fibers, 80 disposed within and/or upon fiberglass mat 61 from passing through the layer 70 of adhesive 71.

In the broadest form of the invention, the adhesive 71 utilized for the adhesive layer 70 may be any suitable material which may adhere, or stick, to the one of the surfaces of mat 61, such as preferably inner surface 63, and provides a form of barrier layer to substantially prevent fiberglass dust particles 80 disposed within the mat 61 from passing through the adhesive layer 70. Adhesive layer 70 is not tacky, whereby the insulation may be readily handled, as previously described. Examples of some materials which may be utilized for adhesive 71 include: conventional water based adhesives, which may be applied to surface 63 and be permitted to dry to not be tacky; spray on starch, such as that which is used for ironing clothes; and conventional hot melt adhesives. Other materials which could serve as adhesives 71 include conventional hairspray and other sprayable, or brushable, coatings or paints which could be applied to surface 63 of mat 61, whereby upon such materials drying, the material is not tacky and any fiberglass dust particles 80 disposed within the mat 61 will be substantially prevented from passing through the layer 70 of adhesive 71. Although conventional hairspray and similar materials might properly function as desired for adhesive 71, it is likely that the use of such materials could present flammability issues in connection with their application and use; however, these materials have been set forth to illustrate the broad nature of the materials which could be utilized as adhesive 71 in the broadest embodiment of the present invention.

Preferably, the layer 70 of adhesive 71 may be subsequently treated to become tacky, whereby the insulation 60 may be secured to the air conditioning equipment 50. If the layer 70 of adhesive 71 is a conventional water based adhesive, which has been allowed to initially dry, the adhesive 71 may be treated by having water applied to the layer 70 of adhesive 71, as by spraying, or brushing on, water, to make the layer 70 of adhesive 71 tacky, so as to permit securing insulation 60 to air conditioning equipment 50. For example, such water based adhesives could be those presently used in the air conditioning industry, or could be the same as or similar, to wallpaper paste which is used on pre-pasted wallpaper. The paste is applied in the wallpaper factory, and the end user activates the adhesive, or paste, by spraying water on the paste, or by dipping the wallpaper in water.

Preferably, the layer 70 of adhesive 71 is subsequently treated by being heated to a temperature at which the layer 70 of adhesive 71 becomes tacky. Preferably, the adhesive 71 is a hot melt adhesive which may be sprayed, or extruded, upon inner surface 63 of mat 61. A preferred example of a suitable hot melt adhesive is a product sold by National Starch and Chemical Company of Bridgewater, N.J., known as VERSA-WELD 34-3210. As is the case with hot melt adhesives, the adhesive is initially a solid material which is heated to a first temperature, whereby the hot melt adhesive may melt and become capable of being sprayed or extruded upon surface 63 of mat 61. Upon being cooled to a second, lower temperature, the layer of hot melt adhesive is not tacky, and may be readily handled by individuals coming into contact with it. Although a high viscous adhesive is preferred, it is believed that low viscous adhesives will also properly function in the present invention.

Alternatively, the first layer 70 of adhesive 71 may be treated to become tacky by having a second layer of a conventional adhesive applied to the first layer 70 of adhesive 71, whereby mat 61 may be secured to air conditioning equipment 50 in the manner previously described. A second layer of adhesive could be used to treat and make the first layer of adhesive to become tacky, if the first layer of adhesive only serves the function of preventing fiberglass dust particles from passing through layer 70 of adhesive 71.

The layer 70 of adhesive 71 is applied to surface 63 as a relatively thin layer 70 of adhesive 71, which would have a thickness sufficient to substantially prevent any fiberglass dust particles 80 from passing through the layer 70 of adhesive 71. The thickness of layer 70 would also be a function of the specific type of adhesive 71 utilized, as would be understood by those skilled in the art.

As shown in FIGS. 2 and 3, insulation 60 may be provided with a layer 90 of foil 91 on the outer surface 62 of mat 61. If desired, at least some of the side edges 64, and preferably all of the side edges 64, of fiberglass mat 61 may also have a layer 70′ of adhesive 71′ disposed thereon. This layer 70′ of adhesive 71′ may be any of the adhesives 71 previously described; however, preferably adhesive 71′ is a water based adhesive, which typically would not be subsequently treated to make it tacky as is the layer 70 of adhesive 71 upon inner surface 63 of mat 61. The layer 70′ of adhesive 71′ may be applied as by spraying, or brushing, or in any other conventional manner, although spraying of the water based adhesive is preferred.

When it is desired to secure insulation 60 to air conditioning equipment 50 the layer 70 of adhesive 71 of insulation 60 may be heated to make the adhesive 71 tacky. The surface 63 of fiberglass mat 61 of insulation 60, with the tacky adhesive 71 thereon, is then placed into contact with the desired outer surface 51 of air conditioning equipment 50. The layer 70 of adhesive 71 may be heated by using a conventional heat lamp, or infrared lamp, 55 (FIG. 1), as by placing the heat lamp 55 in close proximity to the adhesive 71 of insulation 60. Alternatively, a conventional heating plate 56 (FIG. 1), or other heating device, can be used to heat the adhesive by briefly bringing the heating plate 56 into contact with the layer 70 adhesive 71 of insulation 60.

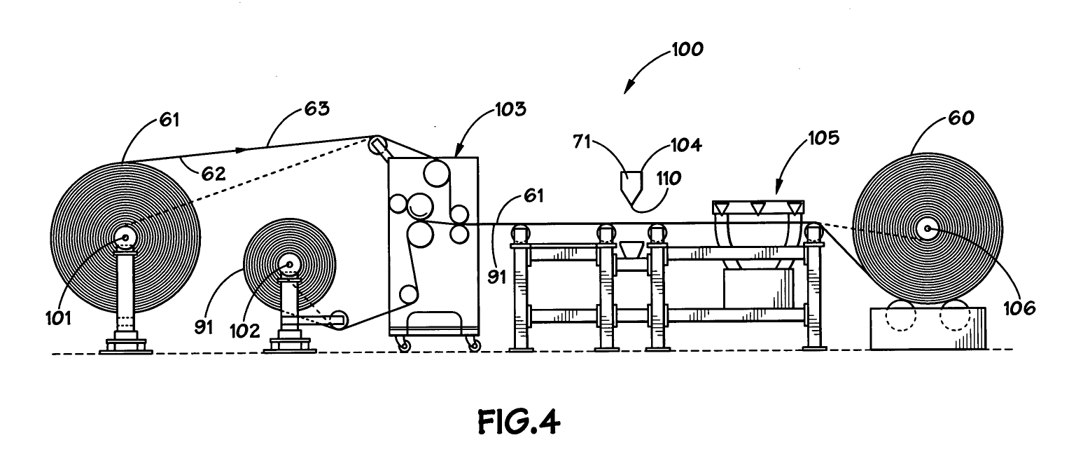

With reference to FIG. 4, an assembly, or manufacturing, line 100, for insulation 60 of the present invention is illustrated, the individual components of which are conventional in their design and operation. Assembly line 100 generally includes: a roller 101 upon which a quantity of fiberglass mat 61 is wound upon, and from which fiberglass 61 may be unwound as it passes through assembly line 100; a foil roller 102 upon which a quantity of foil 91 is disposed, and from which it may be unwound; the fiberglass mat material 61 and foil 91 being drawn into a conventional coater/laminator device 103 which affixes the foil 91 to the outer surface 62 of fiberglass mat 61; and an adhesive dispensing system 104. The fiberglass mat 61 with the foil 91 thereon then passes beneath the adhesive dispensing system 104 which may include a plurality of nozzles 110 through which adhesive 71, which has been heated to a first temperature, may be sprayed in a curtain-like manner across the fiberglass mat material 61 to apply the layer of adhesive 71 upon the inner surface 63 of fiberglass mat 61. For example, the adhesive dispensing system 104 may include suitable control systems, heater(s), pumps, manifold(s), and a plurality of Universal modules, each module including a nozzle, all of which may be obtained from Nordson Corporation, Packaging & Product Assembly Group of Duluth, Ga.

Still with reference to FIG. 4, insulation 60 which now includes the fiberglass mat 61, layer 70 of adhesive 71 disposed thereon, and foil 91 may be then pass beneath a chilling station 105, which cools the adhesive to a second temperature, lower than the first temperature at which the adhesive 71 was heated in the adhesive dispensing system 104, whereby the layer 70 of adhesive 71 cools and is not tacky. Insulation 60 may then be wound upon a storage reel 106 and subsequently formed into insulation 60 having the desired configuration, as by die cutting the insulation 60 into the desired configurations, or shapes, to be affixed to air conditioning equipment 50. Alternatively, in lieu of adhesive dispensing system 104, which heats and sprays adhesive 71 upon fiberglass mat 61, adhesive 71 can be first formed into an adhesive web (not shown) mounted upon a roller and the web of adhesive material can be heated and pressed into contact with the outer surface 63 of fiberglass mat 61.

It is to be understood that the invention is not limited to the exact details of construction, operation, exact materials, or embodiment as shown and described, as obvious modifications and equivalents will be apparent to one skilled in the art. For example, the insulation and methods of the present invention can be used in connection with conventional fiberglass insulation for residential and commercial structures which utilizes a paper layer on one surface of a length of fiberglass mat and non-tacky adhesive on the other surface, and the length of fiberglass mat may be rolled into a cylinder. Accordingly, the invention is therefore to be limited only by the scope of the planes.

1. Insulation for use with air conditioning equipment, comprising:
a fiberglass mat having an outer surface, an inner surface, and a plurality of side edges; and
a layer of adhesive disposed upon at least one of the surfaces, the layer of adhesive not being tacky, whereby the insulation may be readily handled and any fiberglass dust particles disposed within the fiberglass mat will be substantially prevented from passing through the layer of adhesive.

2. The insulation of claim 1, wherein the layer of adhesive is treated to become tacky, whereby the insulation may be secured to the air conditioning equipment.

3. The insulation of claim 2, wherein the layer of adhesive is treated by being heated to a temperature at which the layer of adhesive becomes tacky.

4. The insulation of claim 3, wherein the layer of adhesive is treated by having water applied to the layer of adhesive to make the layer of adhesive tacky.

5. The insulation of claim 2, wherein the layer of adhesive is a first layer of adhesive, and the first layer of adhesive is treated by applying a second layer of adhesive to the first layer of adhesive.

6. The insulation of claim 1, wherein a layer of foil is affixed to one of the surfaces.

7. The insulation of claim 1, wherein a layer of adhesive is disposed upon at least some of the side edges of the fiberglass mat.

8. The insulation of claim 1, wherein a layer of foil is affixed to one of the surfaces.

9. The insulation of claim 1, wherein the layer of adhesive is a hot melt adhesive which is sprayed upon the fiberglass mat at a first temperature and the adhesive is then cooled to a second lower temperature, whereby the layer of hot melt adhesive is not tacky.

10. The insulation of claim 9, wherein the hot melt adhesive, upon being reheated to a temperature greater than the second temperature, is tacky and may be secured to the air conditioning equipment.

11. A method for making insulation for use with air conditioning equipment, comprising the steps of:
providing a fiberglass mat having an outer surface, an inner surface, and a plurality of side edges; and
applying a layer of adhesive upon at least one of the surfaces, the layer of adhesive not being tacky, whereby the insulation may be readily handled and any fiberglass dust particles disposed within the fiberglass mat will be substantially prevented from passing through the layer of adhesive.

12. The method of claim 11, including the step of utilizing an adhesive which may be subsequently treated to become tacky, whereby the insulation may be secured to the air conditioning equipment.

13. The method of claim 12, including the steps of utilizing as the adhesive a hot melt adhesive, and the adhesive is applied by spraying the adhesive upon the fiberglass mat at a first temperature, and the adhesive is then cooled to a second temperature, which is lower than the first temperature, whereby the layer of hot melt adhesive is not tacky.

14. The method of claim 13, including the step of utilizing a hot melt adhesive which may be subsequently reheated to a temperature greater than the second temperature, whereby the layer of adhesive may become tacky and be secured to the air conditioning equipment.

15. The method of claim 12, including the step of utilizing as the adhesive a water based adhesive, which upon having water applied to the layer of adhesive, the layer of adhesive becomes tacky.

16. The method of claim 11, including the step of affixing a layer of foil to one of the surfaces.

17. The method of claim 11, including the step of applying a layer of adhesive upon at least some of the side edges of the fiberglass mat.

18. A method of securing insulation to air conditioning equipment comprising the steps of:
utilizing as the insulation a fiberglass mat having an outer surface, an inner surface, and a plurality of side edges, at least one of the surfaces having disposed thereon a layer of adhesive, the layer of adhesive not being tacky;
heating the layer of adhesive to make the adhesive tacky; and
placing the surface of the fiberglass mat, with the tacky adhesive thereon, into contact with the air conditioning equipment to secure the insulation to the air conditioning equipment.

19. The method of claim 18, including the step of using a heat lamp to heat the adhesive.

20. The method of claim 18, including the step of using a heating plate to heat the adhesive.
